(19) United States
(12) Patent Application Publication
(10) Pub. No.: US 2022/0023868 A1
(43) Pub. Date: Jan. 27, 2022

(54) AUTOMATABLE TEMPERATURE-CONTROL APPARATUS

(71) Applicant: Analytik Jena GmbH, Jena (DE)

(72) Inventors: Claus Knippschild, Jena (DE); Jan Kaiser, Stollberg (DE); Robert Möller, Jena (DE); Christian Paulenz, Jena (DE)

(21) Appl. No.: 17/311,686

(22) PCT Filed: Nov. 28, 2019
(86) PCT No.: PCT/EP2019/082853

§ 371 Date: Jun. 7, 2021

(51) Int. Cl. B01L 7/00; B01L 9/00; G01N 35/04; B01L 3/00

(52) U.S. Cl. CPC B01L 7/52; B01L 9/523; G01N 35/04; B01L 3/50853; G01N 2035/00376; B01L 2200/04; B01L 2300/0829; B01L 2300/1805; B01L 2200/025

(57) ABSTRACT

The present invention relates to an apparatus (1) for controlling the temperature of a sample carrier (2), and to an automatable laboratory workplace comprising an apparatus (1) according to the invention. The apparatus comprises a heating device (2) having a heater (3) and a movable heating cover (6), which is arranged over the receiving region of the heater (3) and is designed to press the sample carrier (4) in a heating position (H) into the receiving region (3a) of the heater (3) with a predefinable contact pressure, and a transport device (8), which is designed to introduce the sample carrier (3) into the apparatus (1) from an insertion position (E) outside the apparatus (1). According to the invention, the transport device (8) comprises a loading unit (9), which comprises a receiving unit (10) for receiving the sample carrier (4) and is movable between an insertion position (E) and an intermediate position (Z), in which the sample carrier (4) is situated inside the apparatus (1) and above the receiving region (3a) of the heater (3). The transport device (8) is arranged and/or designed in such a way that at least the sample carrier (4) is movable from the intermediate position (Z) into the heating position (H) by means of a movement of the heating cover (6). In addition, the transport device (8) comprises at least one return element (11), which is designed to move at least the sample carrier (4) from the heating position (H) back into the intermediate position (Z).

The present invention relates to an apparatus for controlling the temperature of a sample carrier and to an automatable laboratory workplace comprising an apparatus according to the invention.

In the field of biotechnology and molecular biology, a multiplicity of samples are generally to be investigated, especially simultaneously. Sample carriers in the form of microtiter plates offer the possibility of arranging and jointly examining a plurality of samples in a sample carrier. Further approaches in order to handle the ever increasing sample volume consist of increasing the automation of the working steps required in each case for the sample analysis.

Many standard techniques in the stated fields require the performance of thermally controlled process steps for which special temperature control apparatuses are used. For the well-known polymerase chain reaction (PCR), thermocyclers are used, for example, which are independently and automatically capable of independently performing the different temperature cycles of a polymerase chain reaction. Moreover, real-time thermocyclers are equipped with optical systems for measuring fluorescence. Further examples of such temperature control apparatuses are, for example, thermoshakers, microtiter plate readers, or incubators, which are likewise known in the art.

In the simplest case, the sample carrier in question, for example a microtiter plate, is introduced manually into the respective apparatus, for example a thermocycler, and also removed manually therefrom. However, various at least partially automated solutions in connection with temperature control apparatuses have also become known.

In apparatuses which are intended for integration in robot platforms or for use in automated laboratory workplaces, it is necessary to provide an option which allows the respective sample carrier to be inserted into the apparatus and removed therefrom, especially by means of a robot.

In the case of a temperature control apparatus with a so-called lid heater, frequently an, especially automated, option is provided for temporarily removing the lid from the respective heating element.

In other apparatuses a receiving position is in turn provided, in which the respective sample carrier can be inserted into or removed from the apparatus. In this connection, sample receptacles that can be moved out or pivoted out of the respective apparatus, for example, have become known. For example, U.S. Pat. No. 6,197,572 B1 describes a thermocycler having a sample receptacle in the form of a drawer, which can be moved horizontally out of the apparatus. Other apparatuses have ejection mechanisms which are arranged in the region of the sample block and which serve to eject the respective sample carrier in the vertical direction relative to the apparatus.

Typically, the movement mechanisms provided in each case occupy a relatively large amount of space. In addition, in the case of temperature control apparatuses, adhesion frequently occurs between the sample body and the heating unit after the respective heating process. The mechanism must then in each case be able to overcome this adhesive force.

On the basis of this, the object of the present invention is to specify an apparatus for controlling the temperature of a sample, which apparatus is distinguished by a movement mechanism for introducing or removing sample carriers into or out of the apparatus that is as simple and reliable as possible.

This object is achieved by the apparatus according to claim 1 and by the automated laboratory workplace according to claim 15.

With regard to the apparatus, the object underlying the invention is achieved by an apparatus for controlling the temperature of a sample carrier, comprising a heating device with a heating element, which comprise s a receiving region for receiving the sample carrier, and a movable heating cover, which is arranged above the receiving region of the heating element and is designed to press the sample carrier into the receiving region of the heating element in a heating position with a predefinable contact pressure, and a transport device which is designed to introduce the sample carrier into the apparatus from an insertion position outside of the apparatus. According to the invention, the transport device comprises a loading unit, which loading unit comprises a receiving unit for receiving the sample carrier and is movable along a horizontal axis between the insertion position and an intermediate position in which the sample carrier is located within the apparatus and above the receiving region of the heating element. The transport device is arranged and/or designed in such a way that at least the sample carrier can be moved from the intermediate position into the heating position by means of a movement of the heating cover, and has at least one return element, which is designed to move at least the sample carrier from the heating position back into the intermediate position.

The invention thus relates to a temperature control apparatus having a so-called lid heater. The heating element is, for example, a heating block into which the sample carrier can be introduced or adapted. The heating cover is preferably arranged and designed in such a way that, in the event that the heating cover is in the heating position, the sample carrier is preferably substantially completely enclosed by the heating device or rests against or is adapted to the heating cover.

Movement of the heating cover of the heating device advantageously imparts a movement of the sample carrier within the apparatus. For introduction into the apparatus, the sample carrier is first transferred from an insertion position into an intermediate position. This is followed by a further movement from the intermediate position into the heating position. To carry out the second movement, there is advantageously no need for a separate device, since this movement is imparted by the heating cover

It is advantageous if the heating cover can be moved back and forth between a rest position and the heating position, especially along a vertical axis. The vertical axis refers to a longitudinal axis through the apparatus. In the intermediate position, the sample carrier is arranged between the rest position and the heating position of the heating cover. In this case, the heating cover, the sample carrier and the heating element, especially the receiving region of the heating element, advantageously align with one another.

It is also advantageous if the loading unit is designed to execute a movement along a horizontal axis between the insertion position and the intermediate position. For this purpose, the loading unit can have a suitable movement device.

The sample carrier is accordingly first conveyed into the interior of the apparatus by a horizontal movement before it is transferred in the vertical direction from the intermediate position into the heating position by vertical movement of the heating cover. An especially simple and reliable movement mechanism is thus provided which dispenses with the integration of robots or complicated arrangements.

Rather, only one movement mechanism is required for the transport device according to the invention for the back and forth movement of the sample carrier between the insertion position and the intermediate position. The further movement within the apparatus is accomplished by means of the movement of the heating cover, which is provided in any case within the apparatus, or via the at least one return element. Thus, according to the invention, an especially compact and simply constructed, robust temperature control apparatus is provided which is ideally suited for automated operation.

In a preferred embodiment, the apparatus comprises at least one movement device for moving the heating cover. According to the invention, the movement device for moving the heating cover simultaneously serves to move the sample carrier from the intermediate position into the heating position. On the one hand, it is conceivable here that the sample carrier is moved by means of the movement device. However, it is likewise conceivable for a plurality of, especially all, components of the transport device to be moved by means of the movement device.

In this case, it is advantageous if the movement device comprises a motor, especially an electric motor, for example a servo motor or stepper motor. Alternatively or additionally, it is also conceivable for the movement device to comprise a cable pull.

The loading unit can also comprise a movement device for moving the sample carrier between the insertion position and the intermediate position. In this case, the apparatus comprises a first movement device for moving the heating cover and a second movement device for moving the receiving unit of the loading unit. The movement unit of the loading unit may also comprise a motor, especially an electric motor, for example a servo motor or stepper motor and/or a cable pull.

A further preferred embodiment includes the return element comprising at least one magnet. If the heating cover is moved from the heating position back into the rest position, a movement of the sample carrier back into the intermediate position can be achieved by a magnetic force.

An alternative preferred embodiment in turn includes the return element comprising at least one resilient element, especially at least one mechanical spring.

With regard to a return element comprising a resilient element, it is advantageous if the at least one resilient element is deflected from the intermediate position into the heating position by a vertical movement of at least the sample carrier in such a way that a predefinable restoring force is exerted by the resilient element at least on the sample carrier. In the heating position, the pressing force, which is imparted by the contact pressure of the heating cover and holds the sample carrier in the heating position, and the restoring force, which is imparted by the at least one resilient element, then act on the sample carrier. The restoring force is less than the pressing force.

In this case, it is also advantageous if at least the sample carrier can be moved from the heating position into the intermediate position by means of the restoring force exerted by the resilient element. Accordingly, the restoring force is preferably greater than a weight force of at least the sample carrier or of the components of the transport device which are moved by the return element.

It is advantageous if the resilient element is designed in such a way that the restoring force is at least twice as great as an adhesive force which acts between the heating element and the sample carrier after the temperature control of the sample carrier. After a heating process, the sample carrier adheres to the heating element. The restoring force must accordingly be the same as the adhesive force and the weight force.

In a further preferred embodiment, the apparatus comprises a detection unit for detecting the presence of a sample carrier in the apparatus, especially in the loading unit. In this case, the apparatus has a possibility of detecting faults in the course of a heating process in the temperature control apparatus, or a fault during the movement sequences within the apparatus.

It is advantageous if the detection unit comprises a position switch, especially a position limit switch.

The position switch is preferably designed and arranged in such a way that a change in the vertical position of at least the sample carrier or of the components of the transport device, which are moved by means of the heating cover or the return element, can be detected.

Finally, still another embodiment of the apparatus includes the apparatus being a thermocycler, a real-time thermocycler, a thermoshaker, a microtiter plate reader, or an incubator.

The object underlying the invention is further achieved by an automated laboratory workplace comprising an apparatus according to the invention.

It should be noted that the embodiments described in connection with the apparatus can also be applied mutatis mutandis to the automated laboratory workplace.

The invention and its advantageous embodiments are explained in further detail with reference to the following figures. Shown are:

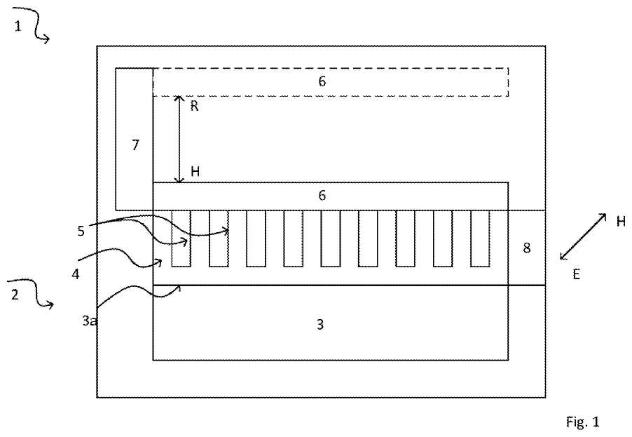

FIG. 1: a schematic drawing of a temperature control apparatus in the form of a thermocycler,

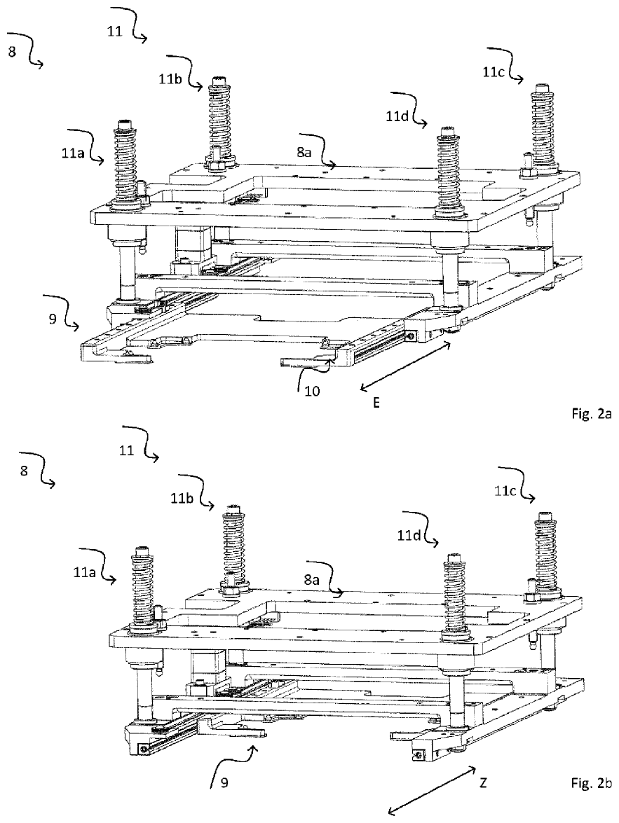

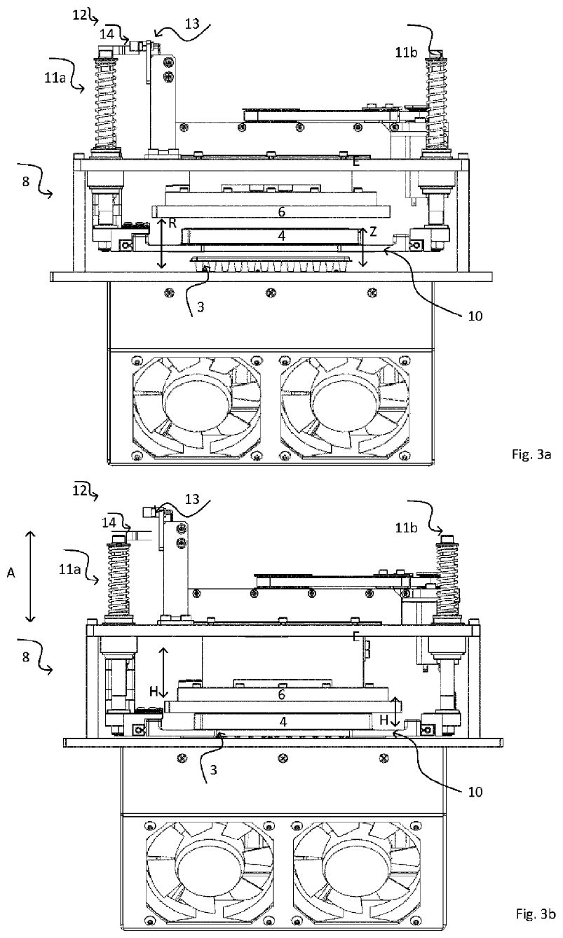

FIG. 2: two perspective views of a transport device according to the invention, wherein the loading unit is (a) in the insertion position and (b) in the intermediate position, and

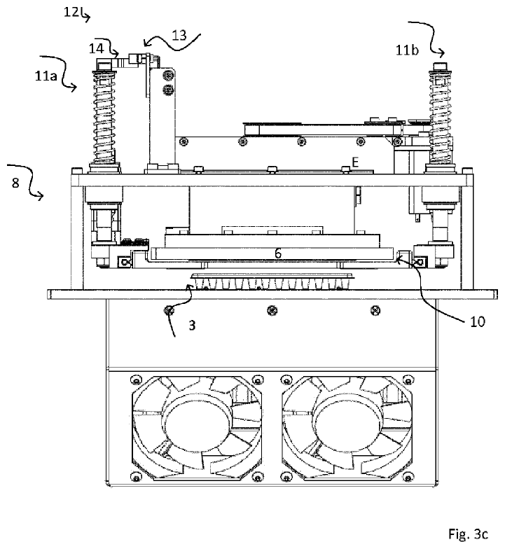

FIG. 3: three sectional views of an apparatus according to the invention comprising a detection unit for detecting the presence of a sample carrier, wherein a sample carrier is present in each case in FIGS. 3a and 3b, while in FIG. 3c the sample carrier is missing.

FIG. 1 shows a schematic drawing of a temperature control apparatus 1 in the form of a thermocycler. The apparatus comprises a heating device 2 in the form of a so-called lid heater comprising a heating element 3 and a movable heating cover 6. The heating element 3 has a receiving region 3a for receiving a sample carrier 4. The sample carrier 4 is designed here in the form of a microtiter plate with a plurality of cavities 5 for receiving a plurality of samples. The apparatus 1 furthermore has a movement device 7 which is designed to move the heating cover 6 back and forth between a rest position R and a heating position H. For the embodiment shown here, the apparatus 1 moves the heating cover 6 along a vertical axis relative to a longitudinal axis.

The apparatus 1 furthermore has a transport device 8 by means of which the sample carrier can be transferred from an insertion position E outside of the apparatus 1 into the apparatus 1.

A preferred embodiment of a transport device 8 according to the invention is shown in FIG. 2. The transport device 8 comprises a loading unit 9, which is shown in FIG. 2a in an insertion position E, in which the sample carrier is arranged outside of the apparatus 1, and in FIG. 2b in an intermediate position Z, in which the sample carrier 4 is arranged within the apparatus. The loading unit 9 comprises a receiving unit 10 for receiving the sample carrier. The movement from the insertion position E into the intermediate position Z takes place along a horizontal axis. To carry out the movement, the loading unit 9 can have a further movement device (not shown separately here).

The transport device 8 furthermore has a return element 11 which, for the present exemplary embodiment, comprises four resilient elements 11a-11d in the form of mechanical springs. In the intermediate position Z, the sample carrier is arranged between the heating cover 6 and the heating element 3 such that the sample carrier 4, the heating cover and the receiving region 3a of the heating element 3 are aligned with one another.

The movement sequences imparted by the transport device 8 are further illustrated in FIG. 3. After the transfer of the sample carrier 4 into the intermediate position Z, a movement of at least the sample carrier 4 from the intermediate position Z into the heating position H is imparted by means of a movement of the heating cover 6. In the present case, not only the sample carrier 4 is moved by the heating cover 6, but also the loading unit 9. Only one base plate 8a of the transport device 8, to which various components of the transport device 8 are fastened, remains in its original position relative to the apparatus 1.

In FIG. 3a the sample carrier 4 is located in the intermediate position Z in the receiving unit 10 of the loading unit 9. The heating cover 6 is in the rest position R.

The apparatus 1 further comprises a detection unit 12 for detecting the presence of a sample carrier 4 in the apparatus 1. The detection unit 12 has a position limit switch 13 for the example shown here. This position limit switch is designed to detect a movement of the sample carrier 4 from the intermediate position Z into the heating position H. For this purpose, a projection 14 is attached to one of the resilient elements 11a, the position of which can be detected by the position limit switch 13.

In FIG. 3b the sample carrier 4 and the heating cover 6 are in the heating position H. The transfer into the heating position H is effected by a vertical movement of the heating cover 6 imparted by the movement device 7. As already mentioned, for the exemplary embodiment shown here, the entire transport device 8 is moved by the movement of the heating cover 6. This results in a deflection A of the resilient elements 11a-11d from their rest position. The deflection A from the rest position of the springs 11a-11d in turn leads to a change in the position of the projection 14 which is detected by the position limit switch 13. In other words: If a vertical movement of the heating cover leads to a change in the position of the projection 14, a sample carrier 4 is located in the apparatus 1.

On the other hand, if there is no sample carrier 4 in the apparatus 1, a change in the position of the projection 14 does not occur at a point in time at which the heating cover 6 reaches a predefinable area around the intermediate position, as illustrated in FIG. 3c. Thus, if no change in position of the projection 14 is detected when the intermediate position Z is traversed by the heating cover, then there is no sample carrier 4 in the apparatus.

When the heating cover 6 is moved by means of the movement device 7 from the heating position H back into the rest position R, the transport device 8 is also moved back into the intermediate position Z. However, the vertical return movement of the transport device 8 into the intermediate position is brought about by the restoring force imparted by the springs 11a-11d. The transport device 8 in accordance with the present invention thus does not require any further, or separate, movement device for carrying out a vertical movement between the intermediate position Z and the heating position H.

The vertical movements of the heating cover 6, of the sample carrier, and any optical components such as are present, for example, in real-time thermocyclers, can be imparted by means of a single movement device 7 for moving the heating cover. The return movement of the sample carrier 4 or of the transport device 8 also results from the restoring force of the springs 11a-11d. The vertical movement of the transport unit 8 including the loading unit 9 can thus be accomplished solely by the integration of the return element 11.

It should be noted that, in addition to the exemplary embodiments shown here, numerous other variants which likewise fall under the present invention are conceivable for the transport device according to the invention. For example, the return element 11 may comprise at least one magnet, or more or less than four resilient elements. The detection unit 12 can also be embodied differently. It is only designed to allow conclusions to be drawn about the presence of a sample carrier 4 in the apparatus 1 on the basis of a vertical movement of the heating cover 6. In addition, the present invention is by no means limited to temperature control apparatus in the form of thermocyclers.

### REFERENCE NUMERALS

1 Temperature control apparatus

2 Heating device

3 Heating element

3a Receiving region of the heating element

4 Sample carrier

5 Cavities in the sample carrier

6 Heating cover

7 Movement device for the heating lid

8 Transport device

8a Base plate

9 Loading unit

10 Receiving unit

11 Return element

11a-11d Resilient elements

12 Detection unit

13 Position limit switch

14 Projection

H Heating position

Z Intermediate position

E Insertion position

A Deflection of the resilient elements

1. Apparatus (1) for controlling the temperature of a sample carrier (4), comprising:
a heating device (2) having
a heating element (3) which has a receiving region (3a) for receiving the sample carrier (4), and
a movable heating cover (6) which is arranged above the receiving region of the heating element (3) and is designed to press the sample carrier (4) in a heating position (H) with a predefinable contact pressure into the receiving region (3a) of the heating element (3), and
a transport device (8),
which is designed to introduce the sample carrier (4) into the apparatus (1) from an insertion position (E) outside of the device (1),
characterized in that
the transport device (8) comprises a loading unit (9),
which loading unit (9) has a receiving unit (10) for receiving the sample carrier (3) and is movable between the insertion position (E) and an intermediate position (Z) in which the sample carrier (4) is located inside the apparatus (1) and above the receiving region (3a) of the heating element (3),
wherein the transport device (8) is arranged and/or designed in such a way that at least the sample carrier (4) can be moved from the intermediate position (Z) into the heating position (H) by means of a movement of the heating cover (6), and
wherein the transport device (8) has at least one return element (11), which is designed to move at least the sample carrier (4) back from the heating position (H) to the intermediate position (Z).

2. Apparatus (1) according to claim 1,
wherein the heating cover (6) is movable back and forth between a rest position (R) and the heating position (H), especially along a vertical axis.

3. Apparatus (1) according to claim 1 or 2,
wherein the loading unit (9) is designed to carry out a movement along a horizontal axis between the insertion position (E) and the intermediate position (Z).

4. Apparatus (1) according to at least one of the preceding claims,
comprising at least one movement device (7) for moving the heating cover (3).

5. Apparatus (1) according to claim 4,
wherein the movement device (7) comprises a motor, especially an electric motor, for example a servo motor or stepper motor.

6. Apparatus (1) according to at least one of the preceding claims,
wherein the return element (11) comprises at least one magnet.

7. Apparatus (1) according to at least one of claims 1-5,
wherein the return element (11) comprises at least one resilient element (11a-11d, especially at least one mechanical spring.

8. Apparatus (1) according to claim 7,
wherein the at least one resilient element (11a-11d) is deflected from the intermediate position (Z) into the heating position (H) by vertical movement of at least the sample carrier (4) in such a way that a predefinable restoring force is exerted by the resilient element (11a-11d) at least on the sample carrier (4).

9. Apparatus (1) according to claim 8,
wherein at least the sample carrier (4) can be moved from the heating position (H) into the intermediate position (Z) by means of the restoring force exerted by the resilient element (11a-11d).

10. Apparatus (1) according to claim 8 or 9,
wherein the resilient element (11a-11d) is designed in such a way that the restoring force is at least twice as great as an adhesive force which acts between the heating element (3) and the sample carrier (4) after the temperature control of the sample carrier (4).

11. Apparatus (1) according to at least one of the preceding claims,
comprising a detection unit (12) for detecting the presence of a sample carrier (3) in the apparatus (1), especially in the loading unit (8).

12. Apparatus (1) according to claim 11,
wherein the detection unit (12) comprises a position switch (13), especially a position limit switch.

13. Apparatus (1) according to claim 12,
wherein the position switch (13) is designed and arranged in such a way that a change in the vertical position of at least the sample carrier (4) can be detected.

14. Apparatus (1) according to at least one of the preceding claims,
wherein the apparatus (1) is a thermocycler, a real-time thermocycler, a thermoshaker, a microtiter plate reader, or an incubator.

15. Automated laboratory workplace comprising an apparatus (1) according to at least one of the preceding claims.
